(19) United States
(12) Patent Application Publication
(10) Pub. No.: US 2021/0089969 A1
(43) Pub. Date: Mar. 25, 2021

(54) Using Routing Rules to Generate Custom Models For Deployment as a Set

(71) Applicant: Aible Inc., San Francisco, CA (US)

(72) Inventors: Arijit Sengupta, San Carlos, CA (US); Jonathan Wray, Danville, CA (US); John Delaney, El Cerrito, CA (US); Jaime Ignacio Rovirosa, San Carlos, CA (US)

(21) Appl. No.: 16/576,449

(22) Filed: Sep. 19, 2019

(51) Int. Cl. G06N 20/10; G06F 16/9038; G06F 3/0481; G06F 3/0484

(52) U.S. Cl. CPC G06N 20/10; G06F 3/04847; G06F 3/04817; G06F 16/9038

(57) ABSTRACT

A method includes receiving input specifying a first selection of a first value of a variable of a dataset, the variable including a set of values associated with a model including a set of submodels, the set of submodels including a first submodel, the first value associated with the first submodel; determining a first routing rule specifying use of the first submodel associated with the selected first value when the model receives the selected first value as input; and deploying the model with the first routing rule. Related apparatus, systems, techniques and articles are also described.

### TECHNICAL FIELD

The subject matter described herein relates to using routing rules to generate custom models and deploying the custom models as a set.

### BACKGROUND

In predictive analytics, predictive modeling can include creating, testing, validating, and evaluating a model to best predict the probability of an outcome. The techniques used for predictive modeling can be derived from applications of, for example, machine learning, artificial intelligence, and statistics. Typically, a model can be chosen based on how well it performs in testing, validation, and evaluation. However, a model that tests, validates, and evaluates well on some training data may underperform under different circumstances.

### SUMMARY

In an aspect, a method includes receiving input specifying a first selection of a first value of a variable of a dataset, the variable including a set of values associated with a model including a set of submodels, the set of submodels including a first submodel, the first value associated with the first submodel; determining a first routing rule specifying use of the first submodel associated with the selected first value when the model receives the selected first value as input; and deploying the model with the first routing rule.

One or more of the following features can be included in any feasible combination. For example, the method can further include receiving the dataset, the dataset including the variable, the variable including the set of values; training, using the dataset, a first candidate model and a second candidate model; determining a first performance of the first candidate model based on output of the first candidate model when the first value is provided as input to the first candidate model; and determining a second performance of the second candidate model based on output of the second candidate model when the first value is provided as input to the second candidate model. The method can further include determining that the first performance is greater than the second performance; associating, in response to determining that the first performance is greater than the second performance, the first candidate model with the first value; and displaying, within a graphical user interface display space, a first icon associated with the first value, the first icon including a first characteristic representative of the first performance. The first candidate model can be included in the model as the first submodel. The set of values can include a second value. The method can further include determining a third performance of the first candidate model based on output of the first candidate model when the second value is provided as input to the first candidate model; determining a fourth performance of the second candidate model based on output of the second candidate model when the second value is provided as input to the second candidate model; determining that the fourth performance is greater than the third performance; associating, in response to determining that the fourth performance is greater than the third performance, the second candidate model with the second value; and displaying, within the graphical user interface display space, a second icon associated with the second value, the second icon including a characteristic representative of the fourth performance. The first characteristic and the second characteristic can include size, color, shape, position, opacity, alignment, shading, origin, border, font, margin, or padding. The method can further include receiving input specifying a second selection of the second value; and determining a second routing rule specifying use of the second candidate model associated with the selected second value in response to receiving the selected second value as input to the model. The model can be deployed with the first routing rule and the second routing rule. The set of submodels can include the second candidate model.

The deploying can include integrating the model into an event-driven computing environment; and providing a network interface with a private internet protocol address as an entry point for the model in the event-driven computing environment. Tthe event-driven computing environment facilitates can receive an input value in the set of values and provide the input value as input to the model. The deploying can include encapsulating the model and the first routing rule in a virtual container configured to share a kernel, binaries, and libraries with a host; and providing the virtual container.

The input can be received from a user, an application, a process, or a data source. The method can further include receiving data characterizing a first input to the model deployed with the first routing rule, the first input including the first value; determining, based on the first routing rule, use of the first submodel in response to receiving the first value as input to the model; determining, using the first input, a first output of the first submodel associated with the first value; and providing the first output of the first submodel as output of the model. Providing the first output can include transmitting, persisting, or displaying the first output.

Determining the first routing rule can include parsing an input signal for the first value; filtering, using the parsed first value, the dataset for records of the dataset including the parsed first value; and associating the filtered records with the first submodel.

The method can include monitoring the deployed model over time at least by determining a first performance of the model at a first time interval, determining a second performance of the model at a second time interval, and comparing the first performance and the second performance. The input specifying the first selection can be received via a slider provided within a graphical user interface display space; and the slider can be configured to adjust the first value at least by a percentage increase or a percentage decrease. The method can include receiving, in response to receiving the input specifying the first selection via the slider, input specifying training the model; partitioning, in response to receiving the input specifying training the model, the dataset on the first value of the variable; and training, in response to partitioning the dataset, the first submodel on a partition of the dataset including the first value of the variable.

The method can include receiving input specifying an operational constraint and a cost-benefit tradeoff; and associating the first submodel with the operational constraint and the cost-benefit tradeoff. The first routing rule can further specify use of the first submodel associated with the operational constraint and the cost-benefit tradeoff.

The model can be associated with an order of priority including a ranking of conditional statements associated with respective submodels in the set of submodels, the first submodel can be associated with a first priority including a first conditional statement, the set of submodels can further include a second submodel, the second submodel can be associated with a second priority including a second conditional statement. The method can include receiving data characterizing a first input to the model, the first input including at least one condition; and selecting, based on the at least one condition satisfying the first conditional statement, the first submodel.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating an example implementation of generating routing rules;

FIG. 2 is a process flow diagram illustrating an example implementation of generating routing rules;

FIG. 3 is a diagram illustrating an example implementation of routing rules;

FIG. 4 is a diagram illustrating an example implementation of a graphical user interface representing values on respective variables of a dataset;

FIG. 5 is a diagram illustrating an example visual representation of a routing rule used to select a submodel associated with a condition of a variable;

FIG. 6 is a diagram illustrating an example prediction generated by selecting specific values of variables;

FIG. 7 is a diagram illustrating an example of prediction embedded in an external system;

FIGS. 8A-B include a process flow diagram illustrating an example implementation of deploying a model with routing rules; and

FIG. 9 is a diagram illustrating an example of a graphical user interface for monitoring a model including a set of submodels deployed in a production environment and receiving live data.

Like reference symbols in the various drawings indicate like elements.

### DETAILED DESCRIPTION

Typically, a model can be provided by a data scientist to perform specific predictions on a specific dataset. The data scientist can train the model for a specific predictive task, assess and fine-tune the performance of the model with respect to the specific predictive task, and deploy the model. But training, assessing, and deploying multiple specialized models by a subject matter expert can be cumbersome and expensive, especially when the models provide inconsistent predictions for some input parameters (e.g., conditions, values of a variable, and/or the like) in the dataset. As such, it can be desirable to train, assess, and deploy multiple models as a set (e.g., a model including a set of submodels) and such that the best predictions can be provided for any given input parameters.

In some cases, however, a model including a set of submodels trained for a specific predictive task can still provide inconsistent predictions when predictions are provided broadly over the entire set of input parameters. When assessing the performance of the submodels, it can be concluded that different submodels can provide different performance for specific input parameters. As such, it can be desirable to train, assess, and deploy a model including a set of submodels with a set of rules indicating which submodel to use for performing a predictive task on a given input parameter.

Accordingly, some implementations of the current subject matter can train, assess, and deploy a model including a set of submodels with routing rules that associate specific input parameters with specific submodels. After determining which submodels offer the best performance for a specified input parameter, the best performing submodel for the specified input parameter can be identified and selected for use by the model in predictive tasks on data that includes the specified input parameter. In this way, the model can be deployed with routing rules that can specify the best performing submodel for a given input that includes the specified input parameter. When the model is deployed, requests for a prediction on a data record can be routed to different submodels based on, for example, the value of a variable (e.g., column) of the data record. As such, reductions in the performance of the model can be avoided.

Accordingly, some implementations of the current subject matter can offer many technical advantages. For example, input parameters of interest can be selected and routing rules associating the input parameters and the respective best performing submodel can be generated in real time. As such, the time spent retraining and reassessing sets of models can be reduced before deployment for performing predictive tasks. And some implementations of the current subject matter can provide an intuitive interface enabling non-technical, non-expert users to create, assess, and deploy the model including the set of submodels and routing rules associating respective submodels with respective input parameters.

And some implementations of the current subject matter can provide a better performing model including a set of submodels. For example, a single model can provide predictions for different input conditions. A prediction can be provided by the model by, for example, adaptively determining a prediction in response to varying input conditions. In addition, some implementations of the current subject matter can provide visualizations illustrating an assessment of the performance of the set of submodels. By reducing the amount of time spent retraining and reassessing sets of models, providing a better performing single model, providing predictions using a single model, and providing visual assessments of the performance of the single model, some implementations of the current subject matter can save temporal and economic costs associated with providing a single model including sets of conditioned submodels, eliminate computational resources required to retrain and reassess the model, and reduce temporal costs associated with assessing the performance of multiple models by subject matter experts. As such, the current subject matter can provide an improved modelling system.

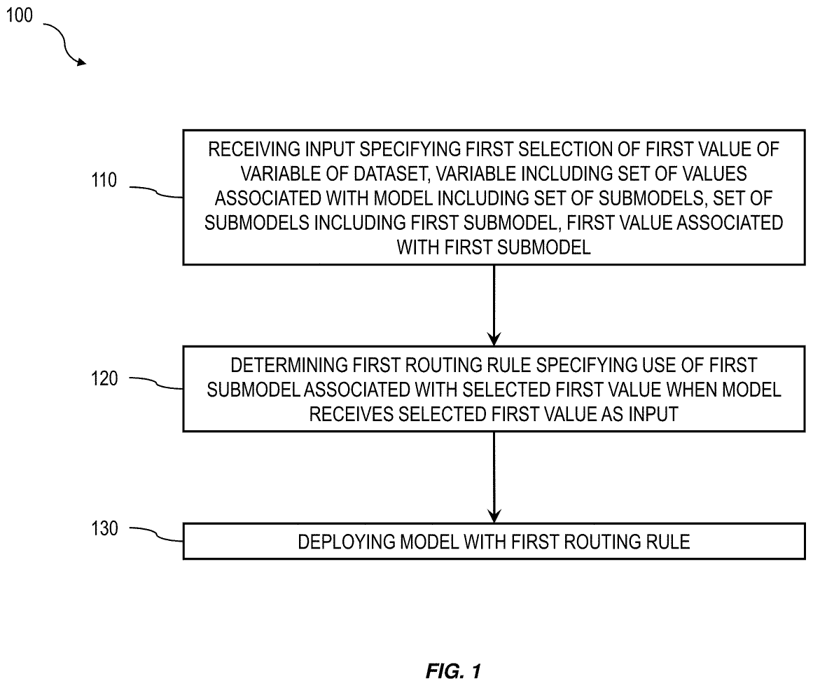

FIG. 1 is a process flow diagram 100 illustrating an example implementation of generating routing rules. By training, assessing, and deploying a single model including a set of submodels with routing rules that associate specific input parameters with specific submodels, the performance of the model can be improved and the amount of time spent retraining and reassessing sets of models can be decreased. As such, computational resources, production time, and production costs can be saved.

At 110, input specifying a first selection of a first value of a variable of a dataset can be received. For example, and as will be described below, the input can specify a selection of a value vₕ_{ₚ} of a variable xₕ^{(j)}. The input can be received from a user, an application, a process, a data source, and/or the like. In some cases, the input can include a user input. The input can specify a first value. For example, the first value specified by the input can specify a value of the variable. The input can be received, for example, from a graphical user interface configured to prompt a user to specify a value of the variable. In some cases, as described below, the variable can include a plurality of possible values and the input can include a first value of the plurality of values. And in some cases, one or more values can be specified by the input. As will be described below, each value of the one or more values can be associated with a respective submodel.

In some cases, the input can be received, for example, from a graphical user interface configured to display icons associated with the value for specifying a value of the variable. The value of the variable received from the input can specify a unique value of the variable. In some cases, the variable can include a plurality of possible values and the input can include a first value of the plurality of values. The variable can include a set of values associated with a model. The model can include a set of submodels. The set of submodels can include a first submodel. The first value can be associated with the first submodel. As will be described below, the value of the variable can include a value of a column of the dataset. In some cases, the model M can include a set of submodels, for example, M={M₁, . . . , Mₖ}, where Mᵢ, i=1, . . . , k, can include a submodel, k can include the number of submodels, and i can include an index of the submodels.

In some cases, the dataset can be received. The dataset Dₙ can include a set of inputs (e.g., records, data entries, and/or the like), for example, Dₙ={x⁽¹⁾, . . . , x⁽ⁿ⁾}, where x^{(j)}, j=1, n, can include an input, and n can include the number of inputs x^{(j)}, j=1, n, where j can include an index of the inputs. Each input x^{(j)}, j=1, n, can include a d-dimensional vector. For example, x^{(j)}=(x₁^{(j)}, . . . , x_{d}^{(j)}), where xₕ^{(j)}, h=1, . . . , d, can include a variable, and h can include an index of the variables. In some cases, the variable can include a column of the dataset.

At 120, a first routing rule can be determined. The first routing rule can specify the use of the first submodel associated with the selected first value when the model receives the selected first value as input. A routing rule Rₕ_{ₚ} can specify a submodel Mᵢ of the model M associated with a value of a variable xₕ^{(j)} of an entry x^{(j)} of the dataset Dₙ. For example, the variable xₕ^{(j)} can include a set of values Vₕ={vₕ_{₁}, . . . , vₕ_{ₘ}}, where vₕ_{ₚ}, p=1, . . . , m. For example, the variable of the dataset can include possible values from the set of values. The value of the variable of the dataset can include, for example, a specific value from the set of values.

For example, the value of the variable can include xₕ^{(j)}=vₕ_{ₚ}. In such a case, the routing rule can specify an appropriate submodel for the given value, for example, if xₕ^{(j)}=vₕ_{ₚ} then use submodel M.

To determine the first routing rule, a first candidate model and a second candidate model can be trained. The performance of the first candidate model and the second candidate model can be assessed. For example, a performance of the first candidate model can be determined and a performance of the second candidate model can be determined. After determining the respective performances of the first candidate model and the second candidate model, the respective performances can be compared. For example, the first candidate model can be determined to outperform the second candidate model, such as by comparing a first performance of the first candidate model and a second performance of the second candidate model and determining that the first performance is greater than the second performance. Once the better performing candidate model is determined (e.g., in this case, the first candidate model), it can be associated with the first value.

For example, the routing rules can include a map associating a given value with a respective submodel, R={(vₕ_{₁}: Mₕ_{₁}), . . . , (vₕ_{ₚ}: Mₕ_{ₚ})}, where vₕ_{₁}, . .. , vₕ_{ₚ} can include values of the variable and Mₕ_{₁}, . . . , Mₕ_{ₚ} can include the respective submodels, where each submodel Mₕ_{₁}, . . . , Mₕ_{ₚ} can be included in the model M (e.g., Mₕ_{₁}, . . . , Mₕ_{ₚ} ∈ M). In some cases the routing rules can be persisted in storage for subsequent use in, for example, providing an output, such as a prediction, by using the submodel indicated by the routing rules for a value in a given input.

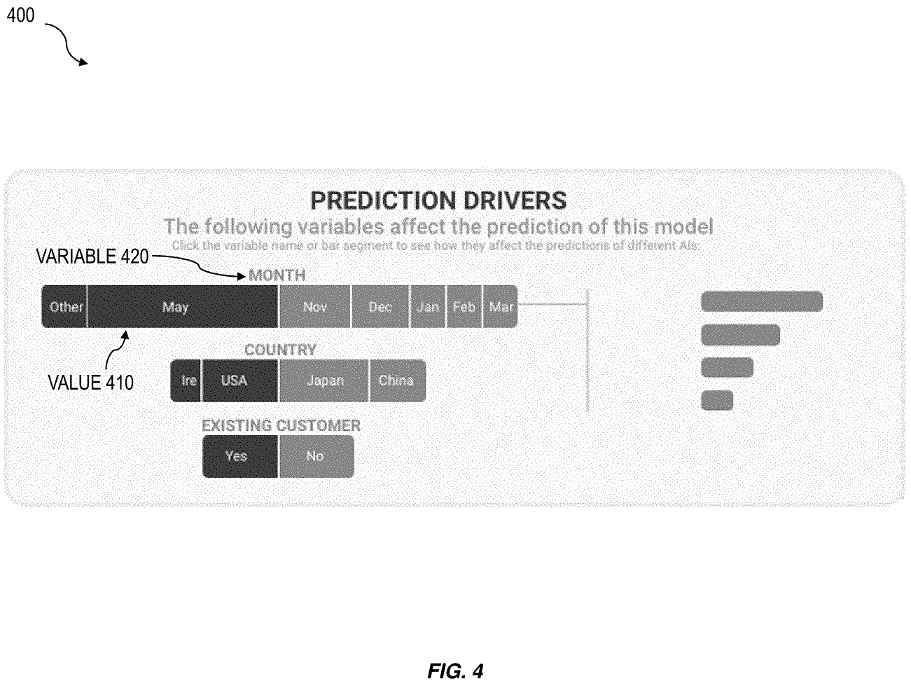

In some cases, an icon associated with the first value can be displayed, such as illustrated in FIG. 4, with the first value including a characteristic representative of the first performance of the candidate models. For example, the characteristic can include size, color, shape, position, opacity, alignment, shading, origin, border, font, margin, or padding. In some cases, the icon associated with the first value can be selected, for example, by user input. The selection of the first value can instantiate inclusion of the better performing candidate model in the set of submodels of the model M. Once inclusion is instantiated, a routing rule specifying the use of the better performing candidate model (e.g., the first candidate model) when an input including the first value of the variable is provided as input to the model M.

At 130, the model M can be deployed with the first routing rule. In some cases, the model can be integrated into an event-driven computing environment, such as AMAZON WEB SERVICES (AWS) LAMBDA. A network interface with a private internet protocol (IP) address can be provided as an entry point for the model in the event-driven computing environment. The event-driven computing environment can facilitate receiving an input value in the set of values and providing the input value as input to the model. In some cases, the model and the first routing rule can be encapsulated in in a virtual container, such as a container provided by DOCKER, and the virtual container can be provided. The virtual container can use operating-system-level virtualization to deliver software in the containers. For example, the virtual container can be configured to share a kernel, binaries, and libraries with a host.

In some cases, data characterizing a first input to the model deployed with the first routing rule can be received. The first input can include the first value. In response to receiving the first value as input to the model and based on the first routing rule, use of a submodel associated with the first value, such as the first submodel can be determined. Following the example described above, the routing rule Rₕ_{ₚ} can specify Rₕ_{ₚ}: if xₕ^{(j)}=vₕ_{ₚ} then use submodel Mᵢ. As another example, suppose the dataset includes two variables (e.g., columns and/or the like) column A and column B. Column A can include ages and column B can include a favorite color. The possible values in column A can include, for example, {34,28,14, 52} and the possible values in column B can include, for example, {red, orange, blue, green}. The data set can include, for example, the entries {(34, green), (14, orange), (14, red), (28, blue), (34, orange), (52, blue)}. The model can include, for example, a submodel corresponding to each color. As an example, the routing rules can associate values of column B including blue with the submodel corresponding to blue. Similarly, the routing rules can associate values of column B including red, orange, and green with the submodel corresponding red, orange, and green, respectively.

Using the first input, a first output of the first submodel can be determined. For example, for a given input x^{(j)}=(x₁^{(j)}, . . . , x_{d}^{(j)}, with xₕ^{(j)} ∈ x^{(j)}, the input can specify the value of the variable xₕ^{(j)}=vₕ_{ₚ} and the submodel Mᵢ associated with the value of the variable can provide its respective output. For example, in a classification with two output classes “positive” and “negative”, the first output yᵢ^{(j)} of the selected submodel Mᵢ associated with the value vₕ_{ₚ} of the variable xₕ^{(j)} of data entry x^{(j)} can include Mᵢ(x^{(j)})=yᵢ^{(j)} (where yᵢ^{(j)} ∈ {positive, negative} corresponds to a “positive” (e.g., a classification as a positive class) or a “negative” (e.g., a classification as a negative class)).

In some cases, the output can specify what is being tested for, such as an input in a medical classifier being classified in the positive class as a tumor or the negative class as not a tumor or an input to an email classifier being classified in the positive class as a spam email or the negative class as not a spam email. In the medical classifier example described above, a variable of the dataset can include the age of the patient. The value of the variable can, for example, include whether the age of the patient is above a specified age or below the specified age. The routing rules can associate a first submodel for patients above the specified age and can associate a second submodel for patients below the specified age. In the email classifier example described above, a variable of the dataset can include the email domain name of the sender of the email. A value of the variable can include, for example, whether the domain name of the sender is the same as the domain name of the recipient. The routing rules can associate a first submodel for senders where the domain name of the sender matches the domain name of the recipient and a second submodel for senders where the domain name of the sender doesn't match the domain name of the recipient.

Further to the Boolean examples described above (e.g., submodel Mᵢ outputting either “positive” or “negative” for a given input), some implementations of the current subject matter can include multivariate models Mᵢ, such that the output of the model includes three or more possible output values. For example, given a model Mᵢ, an input x^{(j)}, where x^{(j)} can include an element of the dataset Dₙ, and an output dimension dₒ, where dₒ≥3, the model can output Mᵢ(x^{(j)})=yᵢ^{(j)}, where yᵢ^{(j)} ∈ {class₁, . . . , class_{d}_{₀}}. For example, if dₒ=3, then the output yᵢ^{(j)} can include either class₁, class₂, or class₃. In some cases, the output can include continuous values, time series values, and/or the like.

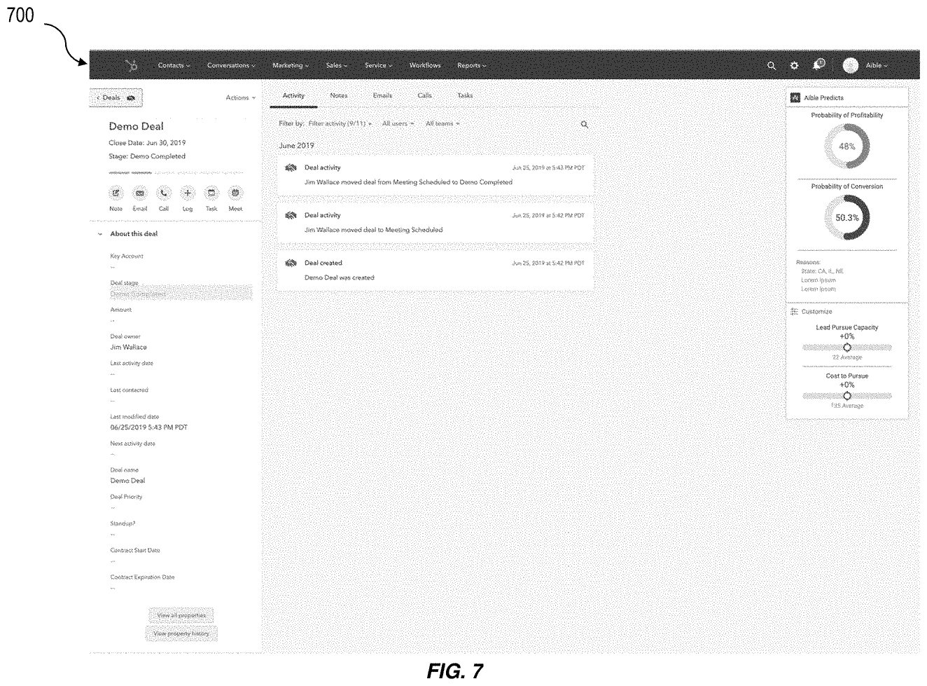

The first output of the first submodel can be provided. As described above, the first output of the submodel (e.g., the submodel selected using the routing rule associating the first value specified in the input with the submodel and/or the like) can be determined. In some cases, the first output can be provided in a graphical user interface display space. For example, a visual representation of the first output can be provided in the graphical user interface display space. For example, FIG. 6 is a diagram illustrating an example prediction generated by selecting specific values of variables in a graphical user interface. For example, as illustrated in FIG. 6, a prediction of “Converted” can be provided for “Term Deposit Conversion” with probability 68.18942% when the value of variable “Last Contact Duration” is selected as “−0.00 to 59.00”, when the value of variable “Contact Month” is selected as “May”, when the value of variable “Euribor 3 Month Rate” is selected as “0.63 to 1.05”, when the value of variable “Consumer Confidence Index” is selected as “−40.30 to −36.40”, when the value of variable “Employment Variation Rate” is selected as “1.10 to 1.40”, and when the value of variable “Consumer Price Index” is selected as “92.89 to 93.20.” In some cases, the first output can be embedded into an external system. For example, FIG. 7 illustrates an example of prediction embedded into an external system.

As described above, the model can include a set of submodels trained on a dataset. The dataset can include a variable. The variable can include at least a first value corresponding to a first value of the variable and a second value corresponding to a second value of the variable. The second value can be different from the first value. As described above, the dataset Dₙ can include a set of inputs (e.g., rows, records, data entries, and/or the like), for example, Dₙ={x⁽¹⁾, . . . , x⁽ⁿ⁾}, where x^{(j)}, j=1, . . ., n, can include an input, n can include the number of inputs x^{(j)}, and j can include an index of the inputs. Each input x^{(j)}, j=1, . . . , n, can include a d-dimensional vector. For example, x^{(j)}=(x₁^{(j)}, . . . , x_{d}^{(j)}) where xₕ^{(j)}, h=1, . . . , d, can include a variable, and h can include an index of the variables. In some cases, the variable can include a column of the dataset. The variable can include data values provided by respective inputs.

For example, a date of birth dataset can include inputs such as name, birth day, birth month, and birth year. For example, a person named “Simba” born Jun. 15, 1994, the corresponding input x^{(j)}={x₁^{(j)}, x₂^{(j)}, x₃^{(j)}, x₄^{(j)}} ={Simba, 15, June, 1994}, where x₁^{(j)} includes a variable corresponding to name, x₂^{(j)} includes a variable corresponding to birth day, x₃^{(j)} includes a variable corresponding to birth month, and x₄^{(j)} includes a variable corresponding to birth year. For example, the variable x₃^{(j)} corresponding to birth month can include values January, February, March, April, May, June, July, August, September, October, November, and December. In this example, the variable can include at least a first value, such as January, and a second value, such as February. A first value of the variable can correspond to the first value (e.g., January and/or the like) and a second value of the variable can correspond to the second value (e.g., February and/or the like).

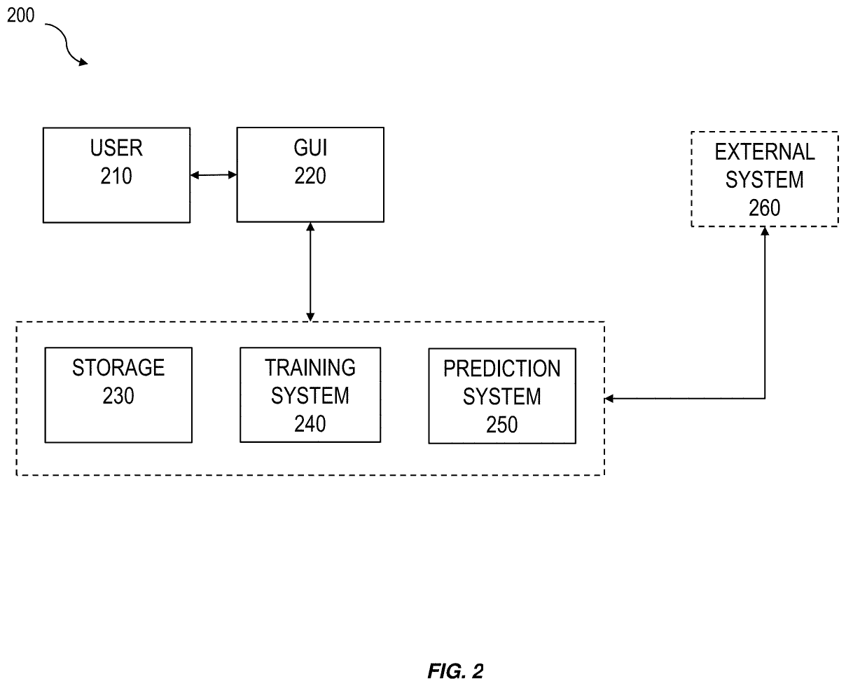

FIG. 2 is a system block diagram illustrating an example implementation of a system 200 for training, assessing, and deploying a model including a set of submodels. System 200 can include graphical user interface (GUI) 220, storage 230, training system 240, prediction system 250, and external system 260. By training, assessing, and deploying a single model including a set of submodels with routing rules that associate specific input parameters with specific submodels, the performance of the model can be improved and the amount of time spent retraining and reassessing sets of models can be decreased. As such, computational resources, production time, and production costs can be saved.

GUI 220 can be configured to receive input from user 210. For example, the input can include a dataset Dₙ={x⁽¹⁾, . . . , x⁽ⁿ⁾} for training the model M={M₁, . . . , Mₖ}, where k is the number of submodels in the model. As another example, the input can include entries of the data set x^{(j)}={x₁^{(j)}, . . . , x_{d}^{(j)}}, variables xₕ^{(j)} (e.g., columns and/or the like) of elements x^{(j)} (e.g., rows and/or the like) of the dataset Dₙ, where, for example, xₕ^{(j)} ∈ x^{(j)}=(x₁^{(j)}, . . . , xₕ^{(j)}, . . . , x_{d}^{(j)}), x^{(j)} ∈ Dₙ, where n is the number of entries (e.g., rows and/or the like) in the dataset, d is the dimension (e.g., number of columns and/or the like) of each dataset entry, j is an index indicating a value in the range {1, . . . , n} (e.g., an index pointing to a data set entry and/or the like), h is an index indicating a value in the range {1, . . . , d} (e.g., an index pointing to a variable of a dataset entry and/or the like).

In some cases, storage 230, training system 240, and prediction system 250 can be provided in a system external to GUI 220. For example, storage 230, training system 240, and prediction system 250 can be hosted in a customer account on AWS and can be configured to communicate with external system 260. Storage 230 can be configured to store (e.g., persist and/or the like), for example, inputs received from GUI 220 such as datasets Dₙ={x⁽¹⁾, . . . , x⁽ⁿ⁾}; entries of the data set x^{(j)}={x₁^{(j)}, . . . , x_{d}^{(j)}}; variables of the entries xₕ^{(j)} ∈ x^{(j)}=(x₁^{(j)}, . . . , xₕ^{(j)}, . . . , x_{d}^{(j)}) and/or the like. As will be discussed below, storage 230 can be configured to store the model including the submodels and the routing rules associating values of variables with respective submodels included in the model. And storage 230 can be configured to store, for example, the performance of the model, assessments of the performance of the model, and/or the like. Storage 230 can include, for example, repositories of data collected from one or more data sources, such as relational databases, non-relational databases, data warehouses, cloud databases, distributed databases, document stores, graph databases, operational databases, and/or the like.

Training system 240 can be configured to train model M={M₁, . . . , Mₖ} on datasets, such as Dₙ={x⁽¹⁾, . . . , x⁽ⁿ⁾}. In some cases, the training of a submodel can be in response to routing rules indicating the data entries of the data set to use for training the submodel. Each submodel Mᵢ ∈ M can be trained on the entries x^{(j)} in the dataset Dₙ using, for example, learning algorithms, such as principal component analysis, singular value decomposition, least squares and polynomial fitting, k-means clustering, logistic regression, support vector machines, neural networks, conditional random fields, decision trees, and/or the like. In some cases, user input can be received specifying a value vₕ_{ₚ} on a variable xₕ^{(j)} of a data entry x^{(j)}, and a submodel Mₖ₊₁ can be generated and trained on elements of the dataset including the value of the variable (e.g., a partition of the dataset including values of variable corresponding to the condition and/or the like). The routing rules can, for example, specify that the value vₕ_{ₚ} can be associated with the submodel Mₖ₊₁.

Prediction system 250 can be configured to determine an output of the model including the output of submodels including the model. As discussed above, the output of the model can include the outputs of the submodels included in the model given an input M(x^{(j)})={M₁(x^{(j)}), . . . , Mₖ(x^{(j)})}={y₁, . . . , yₖ}=Y. In some cases, prediction system 350 can provide the output of a submodel selected using routing rules specifying the submodel in response to an input variable including a value (e.g., a condition) associated with the submodel. In some cases, prediction system 250 can be configured to assess the performance of model, such as M={M₁, . . . , Mₖ}.

In some cases, prediction system 250 can interact with an external system, dataset, and/or the like. For example, outbound shipping information for a distribution center can be loaded into external system 260, such as an enterprise resource planning system illustrated in FIG. 7. The shipments can be sent to prediction system 250 as they ship and can be routed to a submodel depending on the destination of the shipment. For example, items being shipped to Ohio can be scored by a submodel associated with the Midwest, items being shipped to New York can be scored by a submodel associated with the East Coast. Prediction system 250 can be configured to provide a prediction using the respective submodel for each variable, for example, a delivery date for each shipment based on historical data associated with a value of the variable, such as prior shipment delivery dates to the respective destinations. The prediction can be provided by prediction system 250 to external system 260.

In some cases, storage 230, training system 240, and prediction system 250 can be provided external to the modelling system. For example, storage 230, training system 240, and prediction system 250 can be hosted on third-party systems

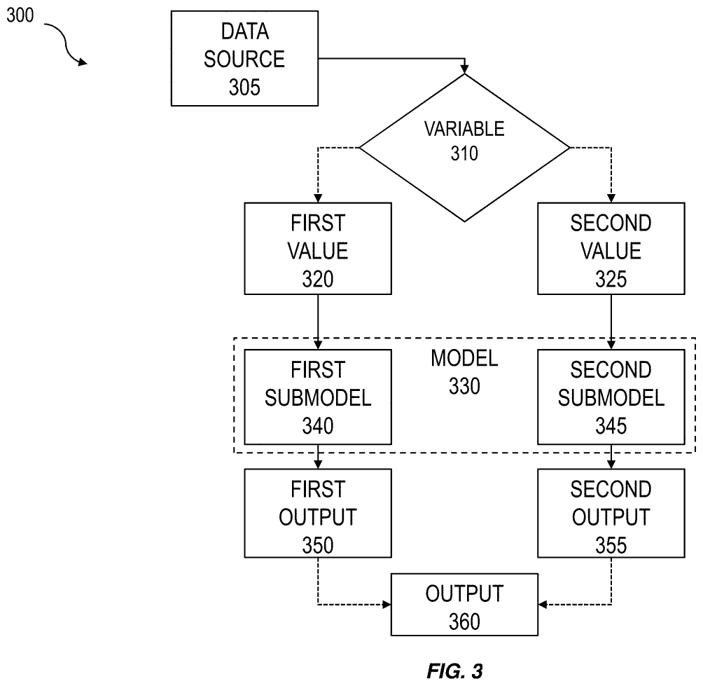

FIG. 3 is a diagram illustrating an example implementation of routing rules. By training, assessing, and deploying a single model including a set of submodels with routing rules that associate specific input parameters with specific submodels, the performance of the model can be improved and the amount of time spent retraining and reassessing sets of models can be decreased. As such, computational resources, production time, and production costs can be saved.

To illustrate routing rules, consider the following example. Data source 305 can include a value of variable 310. In some cases, data source 305 can include the raw data to be scored (e.g., used as input by a model for providing a prediction, a score, and/or the like). The variable conditions can route the data to the correct submodel, the prediction can be determined, and the prediction can be provided with the user unaware of the path (e.g., the routing rules) taken as the experience can be no different than if using a single model. For example, a variable 310, such as “count”, can include the possible values {“primo”, “secundo”, “tertio”, “quarto”} and user input 305 can include a value of the variable. For example, the routing rules can specify that the value “tertio” of “count” variable 310 forms first value 320 associated with first submodel 340 and the value “secondo” of “count” variable 310 forms second value 325 associated with second submodel 345. When “tertio” is received from data source 305 then data source 305 can specify first value 320 on “count” variable 310. When “secundo” is received from data source 305 then data source 305 can specify second value 325 on “count” variable 310.

For example, data source 305 can include the condition “tertio” on “count” variable 410. Since “tertio” corresponds to first value 320, the routing rules can be used to select first submodel 340 of model 330. As described above, in some cases first submodel 340 can be trained on records in the dataset where the value of “count” variable 410 includes “tertio”. With first submodel 340 selected, first output 350 of first submodel 340 can be determined and provided as output 360. In another example, data source 305 can include the condition “secondo” on “count” variable 410. Since “secundo” corresponds to second value 325, the routing rules can be used to select second submodel 345 of model 330. As described above, in some cases, second submodel 345 can be trained on records in the dataset where the value of “count” variable 410 includes “secundo”. With second submodel 345 selected, second output 355 can be determined and provided as output 360.

FIG. 4 is a diagram illustrating an example implementation of a graphical user interface 400 visually representing values 410 of respective variables 420 of a dataset. By training, assessing, and deploying a single model including a set of submodels with routing rules that associate specific input parameters with specific submodels, the performance of the model can be improved and the amount of time spent retraining and reassessing sets of models can be decreased. As such, computational resources, production time, and production costs can be saved.

Graphical user interface (GUI) 400 can include a visual representation of drivers of predictions provided by a model on a dataset. In the example provided in FIG. 4, the dataset can include three variables “month”, “country”, and “existing customer”. The variable “month” can include the values twelve months of the year “January” through “December”. The variable “country” can include the values “Ireland”, “United States”, “Japan”, and “China”. The variable “existing customer” can include the values “yes” and “no”. Each value of a respective variable, such as “May” can correspond to a value 410 of the variable 520. Additionally, routing rules can be generated and used to perform predictions on the dataset. For example, with reference to FIG. 4, the conditions “Other”, “May”, “November”, “December”, “January”, “February”, and “March” can each be associated with a respective submodel trained on records of the dataset including the respective condition. For example, value 410 corresponding to “May” can be associated with a submodel trained on entries of the dataset with values of the “month” variable 420 values corresponding to “May”.

GUI 400 can be provided to a user on a graphical user interface display space and the user can interact with elements of GUI 400. For example, the user can select value 410 (e.g., “May” and/or the like) by clicking a mouse button while a cursor is hovering over the GUI element associated with value 410, by touching a touch screen display screen, and/or the like. When value 410 is selected (e.g., provided as user input and/or the like), the routing rules can be used to determine the submodel associated with value 410. In this example, when “May” is selected, the submodel associated with the condition “May” on the “month” variable is selected. An output of the submodel associated with the condition “May” on the “month” variable can be determined and provided.

As described above, the selected submodel can provide an output. In some cases, the output can include a classification of the user input selected from a set of two or more classes. In some cases, the value of the variable can be unique. In some cases, the performance of the model including the submodels can be assessed. For example, the performance of the output of each of the submodels in the model can be assessed and a visual representation of the performance of the model can be provided as a function of the variable. In some cases, deploying the model can include integrating the model into an existing production environment to be used to perform predictions.

In some cases, routing rules used to split the model can be determined at model training, and as illustrated in FIG. 3 and FIG. 4. For example, these rules can be based on variables and conditions specified by the training data. Once all the submodels are trained, they can be deployed simultaneously to an event-driven, serverless computing platform using an automated deployment step. For example, in AWS, a RESTful application programming interface (API) can be created on an AWS Lambda resource. In the case of a split model (e.g., a model including a set of submodels and routing rules), all submodels can be published when that button is pressed. In some cases, serverless resources can incur costs only when the resource is utilized. For example, a split model with 50 sub models costs no more than a single model as the compute spend can be identical for one model or for 50 submodels. In server based deployments, however, single models were used because each model would require a server spinning 24 hours a day. Once the submodels are deployed the splitting rules can be repurposed as routing rules. Since the variables and values used for the model splits will also be present in the incoming data, scoring requests (e.g., requests for predictions, and/or the like) can be routed to the submodel that matches the valuess present in the scoring request data. The submodel associated with that value can be invoked to provide a prediction, and an output of the submodel (e.g., a score, prediction, and/or the like) can be returned. The deploy step can still include a one click process and hard-coding custom routing rules by the users can be avoided, as the routing rules can be captured and executed automatically.

For example, a model including a set of submodels with routing rules can also accommodate different styles and strategies at an individual level. Take for example a sales team. An average sales rep can target 100 deals per year and win 50 at $50k each for a total of $2.5m. All reps can be paid the same base and commission. A traditional single model deployed at the company can provide reps with 100 deals per year at an average of $50k each. Most of the reps like the model, but there are a few that don't, two of these individuals are always among the top 5 performers annually.

Mitch is a rust belt native and knows everyone in the industry for 300 miles in any direction he wins 260 of the 300 deals he pursues per year and his average win is $15k for a total of $3.9m and an 87% win rate, Mitch has the lowest cost per deal, and a significantly higher capacity than most. Steve covers the West Coast and targets series B & C startups. He targets 30 deals per year and only wins 4 for a 13% win rate. Steve has the highest cost per deal and lowest capacity in the country, but at $1m per win he does very well. Mitch doesn't get enough leads and they are all too high in value to win at a high percentage. Steve gets too many leads and none of them are the type he is looking for. The company could train models for each individual, but there is limited data, especially for Steve, and models cost >$100k to develop, deploy and maintain.

A model including a set of submodels with routing rules can adjust to the strategies, costs, constraints, and/or the like of each individual by selecting the model on an efficient frontier that can be suited to each individual. The submodels can be trained with all the sales data, but because the efficient frontier can be defined for any impact ratio, cost-benefit, constraint, and/or the like, the model including a set of submodels with routing rules can surface the most appropriate leads for each individual, overcoming the limitations of small datasets for each individual. This feeds back to the strategy again because Steve's leads are coming from one of two submodels in the model including a set of submodels with routing rules, the business can look across other regions and see that those submodels are also surfacing leads in New York and Boston, enough to justify adding two additional individuals with a similar focus in each of those cities. The business can also see that most of Steve's leads are coming from a constrained model, not the highest impact model, and two more people would be needed to meet the full demand on the West Coast.

Although a few variations have been described in detail above, other modifications or additions are possible. For example, the single model including the set of submodels can be trained using a set of different resourcing levels (eg., constraints and/or the like) and cost-benefits on the input. In some cases, the single model including the set of submodels can be represented as an ensemble model and can allow for interaction with the set of submodels by interacting with the ensemble model. For example, each submodel in the model can be trained with each of the different resourcing levels on a given input and the performance of each model can be assessed under each of the different resourcing levels.

As described above, routing rules can be generated for the submodels trained with respective resourcing levels. In some cases, the resourcing levels can provide respective conditions on the variables (e.g., specified values of the variables) of the dataset. In some cases, the resourcing levels can provide conditions on the output of the model. For example, the submodels, M={M₁, . . . , Mₖ} (where Mᵢ ∈ M is a submodel) can be trained using a set of resourcing levels (e.g., constraints and/or the like), C={c₁, . . . , cₚ} (where cᵢ ∈ C is a constraint). In some cases, the submodels can be represented as an ensemble model. The routing rules can associate the provided conditions (e.g., resourcing levels, constraints, and/or the like) with respectively trained submodels. In response to receiving user input specifying a condition (e.g., resourcing levels, constraints, and/or the like) on the variable, the routing rules can be used to select the submodel associated with the value of the variable specified by the user input.

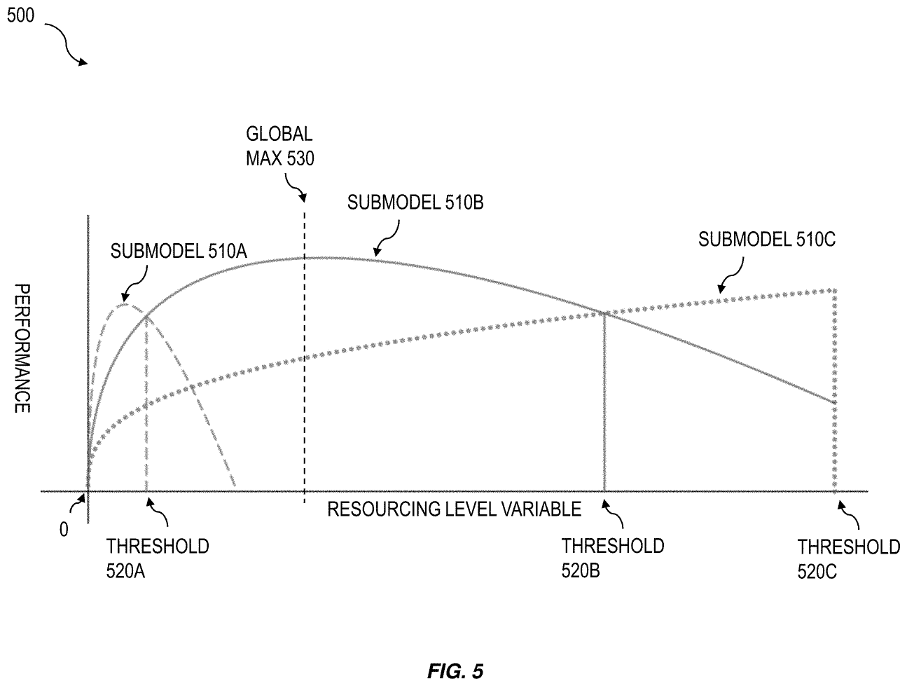

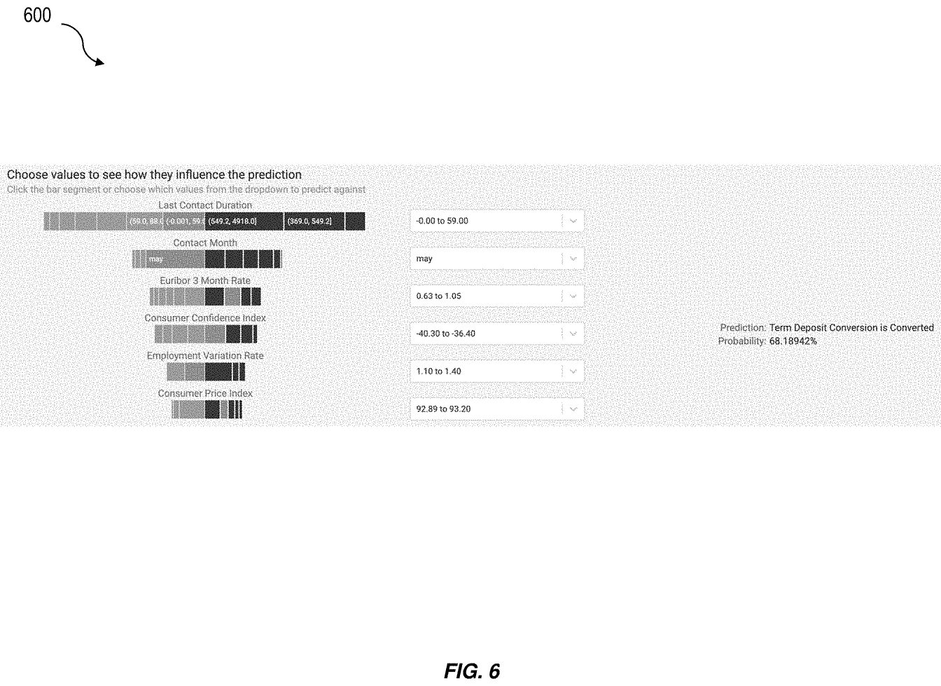

For example, FIG. 5 is a diagram illustrating an example visual representation 500 of a routing rule used to select the submodel associated with a condition of a variable, such as described in U.S. patent application Ser. No. 16/512,647, filed Jul. 16, 2019, the entire contents of which is hereby incorporated by reference herein. In some cases, visual representation 500 can include a feasible performance region including a set of intervals I={(a₁, a₂), . . . , (aₚ₋₁, aₚ)} and, for each interval (aᵢ, aᵢ₊₁), the associated submodel M₍ₐ_{ᵢ}, αᵢ₊₁)=Mₗ such that Mₗ can include the optimally performing submodel in the interval (aᵢ, aᵢ₊₁). By training and assessing multiple submodels under different resourcing levels and providing an intuitive representation of the performance of the models under the different constraints, the submodel most appropriate for a given operational constraint can be selected. As such, the performance of the model including the submodels can be improved and computational resources, production time, and production costs can be saved.

The visualization 500 can include, for example, a graph of performance as a function of the resourcing variable. In some cases, performance can include impact. The output of each submodel can be graphed. FIG. 5 illustrates the output of three submodels, submodel 510A, M_{A}, submodel 510B, M_{B}, and submodel 510C, M_{C}. As illustrated in FIG. 5, below threshold 520A the performance of submodel 510A is optimal (e.g., submodel 510A maximizes impact), between threshold 520A and threshold 520B the performance of submodel 510B is optimal, and after threshold 520B the performance of submodel 510C is optimal. The intervals can be defined as I={(a₁, a₂), (a₂, a₃), (a₃, a₄)}, where a₁=0, a₂=threshold 520A, a₃=threshold 520B, a₄=threshold 520C. Then, the feasible performance region can include a correspondence between an interval and an optimal submodel for the respective interval. For example, with reference to FIG. 5, the feasible performance region can include, Feasible Performance Region={(a₁, a₂): M_{A}, (a₂, a₃): M_{B}, (a₃, a₄): M_{C}}. To the user, visualization 500 can represent the performance of the submodels (e.g., M={M_{A}, M_{B}, M_{C}} and/or the like) and the submodels can be treated as a single model. In some cases, a slider, such as in the customize section of FIG. 7, can be provided to facilitate varying the value of the variable, such as a constraint. With reference to FIG. 7, the variable can include, for example, “Lead Pursue Capacity”, “Cost to Pursue”, and/or the like. In response to varying the constraint, an appropriate submodel, such as the best performing submodel for a respective constraint, can be determined, selected, provided, and/or the like. In some cases, the slider can vary the constraint between intervals, where each interval is associated with a respective optimal submodel.

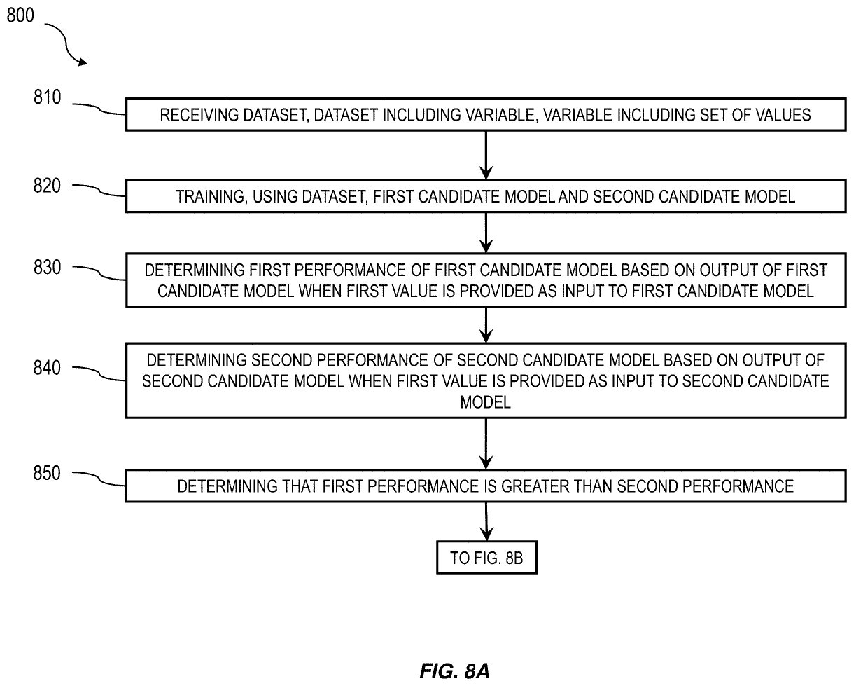

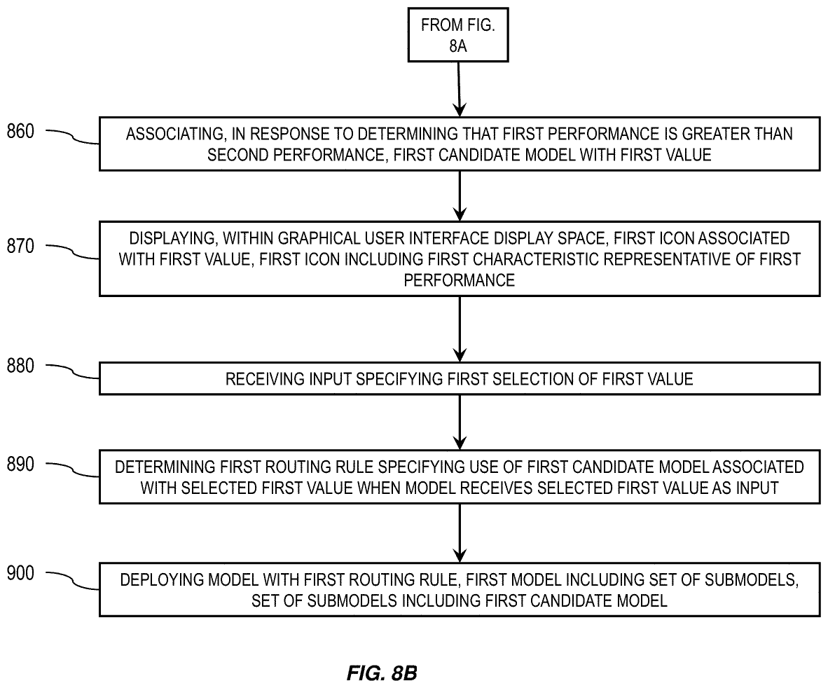

FIGS. 8A-B include a process flow diagram 800 illustrating an example implementation of deploying a model with routing rules. By training, assessing, and deploying a single model including a set of submodels with routing rules that associate specific input parameters with specific submodels, the performance of the model can be improved and the amount of time spent retraining and reassessing sets of models can be decreased. As such, computational resources, production time, and production costs can be saved.

At 810, a dataset can be received. The dataset can include a variable. The variable can include a set of values. At 820, a first candidate model and a second candidate model can be trained using the dataset. For example, the first candidate model and the second candidate model can be included in a pool of candidate models including, for example, thousands of candidate models. In some cases, the entire pool of candidate models is trained using the dataset. A candidate model can include a model for which the performance on inputs including a specific value of a variable will be automatically assessed. As will be described below, some implementations of the current subject matter can facilitate assessment of a pool of candidate models, selection of a value, association of the best performing candidate model for the selected value with the selected value, and deployment of a single model including the candidate model as a submodel.

At 830, a first performance of the first candidate model can be determined. The first performance can be determined based on an output of the first candidate model when a first value is provided as input to the first candidate model. For example, if the output of the candidate model is impact, then the first performance can include the impact. At 840, a second performance of the second candidate model can be determined. The second performance can be determined based on an output of the second candidate model when the first value is provided as input to the second candidate model. In some cases, as described above, the respective performances of the first candidate model and the second candidate model can include accuracy, recall, and/or other metrics used for evaluating model performance.

At 850, the first performance can be determined to be greater than the second performance. Following the above example where performance includes impact, the impact output by the first candidate model can, for example, be compared to the impact output by the second candidate model. After comparing the first performance to the second performance and determining that the first performance is greater than the second performance (e.g., determining that the first candidate model outperforms the second candidate model), at 860, the first candidate model can be associated with the first value. The first candidate model can be associated with the first value in response to determining that the first performance is greater than the second performance.

At 870, a first icon associated with the first value can be displayed. The first icon can be displayed within a graphical user interface display space. The first icon can include a first characteristic representative of the first performance. For example, with reference to FIG. 4, the icon of value 410 is displayed in a graphical user interface display space. In some cases, such as in FIG. 4, candidate models can be assessed for multiple values and icons for each value can display the relative importance of each value of the variable, for example, in proportion to the relative performance of the best performing model of each respective value. For example, the icon representing the value “May” is larger and a different color than the icon representing the value “November”. In FIG. 4, for example, width can indicate strength, with items on the left having a negative impact on the outcome and items on the right having a positive impact on the outcome.

At 880, input specifying a first selection of the first value can be received. For example, a user can select an icon displayed within the graphical user interface display space. In some cases, the input can be received from various sources, such as a data source, a process, an application, and/or the like. The selection of a value can instantiate generation of routing rules associated with the respective selected values and inclusion for deployment of the best performing candidate models, for a given selected value, in the set of submodels of the single model. In some cases, one or more values impacting performance of the model can be provided. A user can be prompted to confirm generating routing rules with the best performing candidate models associated with respective provided values and deploying a model and the routings rules, with the model including a set of submodels including the respective best performing candidate models.

At 890, a first routing rule can be determined. The first routing rule can specify use of the first candidate model when a model receives the selected first value as input. As described above, the first candidate model can be associated with the selected first value, for example, based on the first candidate model outperforming other candidate models on inputs including the first value. At 900, the model with the first routing rule can be deployed. The model can include a set of submodels. The set of submodels can include the first candidate model. As described above, the model can be deployed by integration into an event-driven computing environment, by encapsulation in a virtual container, and/or the like.

The subject matter described herein provides many technical advantages. For example, model maintenance can be greatly simplified. Users can have the ability to upload datasets specific to the splits, or they can generate hundreds of models from a single dataset. The split rules and training settings can be all retained for each split, users can upload and update a dataset or datasets and click retrain to update hundreds or thousands of models all at once. If only a specific split branch is impacted, users can elect to retrain only a single branch which still may contain hundreds of models itself.

For companies that prefer to deploy models in their own servers, these model sets can be Dockerized and deployed locally, still maintaining the routings making it straightforward to build, host, and update without the need to generate individual models and complex routing rules.

In some cases, the model can be split automatically. In some cases, users can be provided with prompts to guide the splitting of the models based on areas of underperformance or changes in performance over time. In some implementations, the model generation platform can automatically identify subgroups of data within a dataset during model generation and/or for a model that is in production (e.g., being used for classification on real data, is considered “live”, and the like) for which the model has a lower performance relative to other subgroups of data. A recommended course of action for the user can be provided to improve the associated predictive model. These recommended courses of action can include terminating further training of the model, creating a split-model (e.g., an additional model for the lower performing subgroup), and to remove the subgroup from the dataset. If multiple models all underperform with the same subgroup, then that subgroup can be flagged for additional action. An interface can be provided during the model generation process for implementing the recommendation, including terminating model generation, splitting the model, and modification of the training set. For example, an interface can be used during model generation in which underperforming subgroups have been identified, and a recommendation to take action to improve model performance is provided. The recommendation can include splitting models, terminating the remainder of the model generation run, and to remove subgroups manually. In some cases, interfaces that can visualize subgroups for which the models are underperforming and provide a recommendation to take action to improve model performance can be provided.

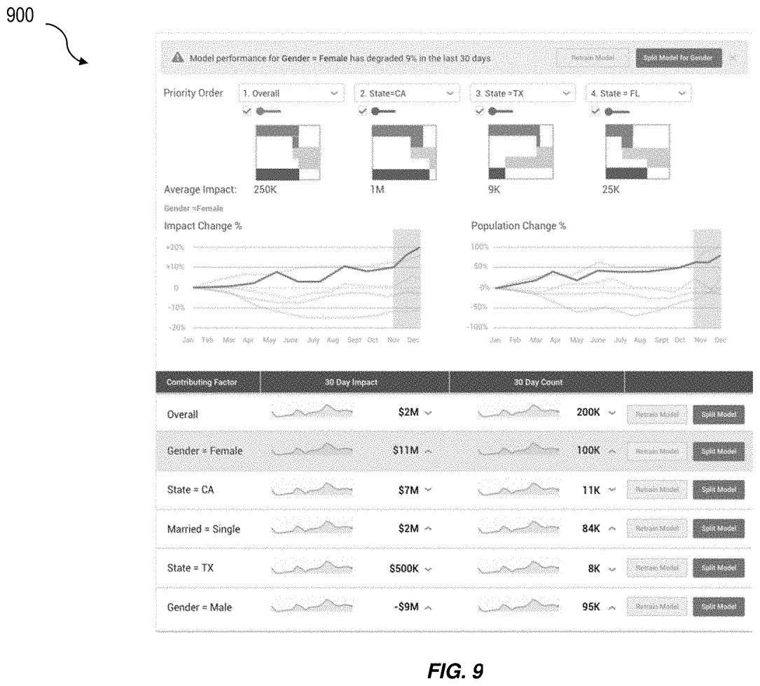

FIG. 9 is a diagram illustrating an example of a graphical user interface 900 for monitoring a model including a set of submodels deployed in a production environment and receiving live data. By training, assessing, deploying a single model including a set of submodels with routing rules that associate specific input parameters with specific submodels, and monitoring the performance of the model after deployment, the performance of the model can be improved and the amount of time spent retraining and reassessing sets of models can be decreased. As such, computational resources, production time, and production costs can be saved.

In some cases, the model can be monitored periodically, such as every hour, day, week, month, and/or the like. The performance of the model during a first time interval (such as a first month, and/or the like) can be compared to the performance of the model at a second, subsequent, time interval (e.g., such as a second month, and/or the like). In some cases, monitoring the model can include assigning a priority order for monitoring, determining the performance of the model over time, prompting a user in response to identifying model degradation, and/or the like.

In some cases, monitoring the model can include assigning an order of priority for splitting the model. For example, the order of priority can include a ranking of conditional statements corresponding to respective submodels split on the conditions specified in the conditional statements, as will be discussed below. Assigning an order of priority for splitting the model can include selecting respective values of variables and associating each value of a variable with a priority. In some cases, the model can be deployed with the order of priority. When deployed, the order of priority can be used to select the submodel. For example, in response to receiving an input to the model, the input can be logically parsed to determine respective values of variables. Once the input is parsed and the respective values of variables are determined, the order of priority can be used to determine which submodel the input will be selected for providing an output. For example, the input can be parsed for conditions and the parsed conditions can be compared against the conditional statements associated with submodels in the order of priority.

In some cases, an input can satisfy the conditional statements determining if a submodel can apply to the particular input (e.g., record, subgroup of dataset, and/or the like). The performance of each submodel with conditions satisfied by the input can be assessed. For example, the performance of a first submodel and the performance of a second submodel, with the priority of the first submodel greater than the priority of the second submodel, can be assessed. After assessment, if the performance of the second submodel is determined to be greater than the performance of the second submodel, the order of priority can be adjusted such that the second submodel has a greater priority than the first submodel, or a test ratio can be established with a percentage of predictions being provided by the second submodel and a percentage of predictions provided by the first submodel. For example, a dataset can include three variables (e.g., “Individual”, “State”, and “Income”), and a model can include 8 submodels with various conditional statements:

TABLE 1

| Individual | State | Income |
|---|---|---|
| Individual A | New York | $200k |
| Individual B | Illinois | $35k |
| Individual C | Texas | $75k |

TABLE 2

| Submodel | Conditional Statement |
|---|---|
| Submodel 1 | State = Texas & Income > $100k |
| Submodel 2 | State = California & Income > $150k |
| Submodel 3 | State = New York & Income > $125k (Prediction for A) |
| Submodel 4 | State = Texas (Prediction for C) |
| Submodel 5 | State = California |
| Submodel 6 | State = New York (Reference Prediction #1 for A) |
| Submodel 7 | State = Any & Income < $50k (Prediction for B) |
| Submodel 8 | State = Any (Reference Prediction: |
| | #2 for A, #1 for B, #1 for C) |

For example, a prediction for an individual living in New York with an income of $200k (e.g., Individual A) can be satisfied by a specific submodel for individuals in New York with incomes greater than $125k (e.g., Submodel 3), a specific submodel for all individuals in New York (e.g., Submodel 6), or a general submodel for individuals in any state (e.g., Submodel 8). If the submodel with the highest priority is the submodel for individuals in New York with incomes greater than $125k (e.g., Submodel 1), the other two submodels (e.g., submodel 3 and submodel 6) can be used to provide reference predictions to determine if the lower priority submodels (e.g., submodel 3 and submodel 6) can outperform the specific model. If the submodel for individuals in New York with incomes greater than $125k underperforms the submodel for all individuals in New York, the priority of the submodels can be changed so that the submodel for all individuals in New York can provide the prediction for the individual, and the submodel for individuals in New York with incomes greater than $125k can be used for reference predictions, or a ratio can be set where the submodel for all individuals in New York provides for example 75% of the predictions and the submodel for individuals in New York with incomes greater than $125k provides the remaining 25%. Model prediction performance can be tracked for individual models and actual predictions returned by any set of N or N+1 models.

For example, with reference to FIG. 9, the “Overall” model can be assigned a first priority. The value “CA” of the variable “State” can be assigned a second priority, the value “TX” of the variable “State” can be assigned a third priority, the value “FL” of the variable “State” can be assigned a fourth priority, and/or the like. The assigned priority can be used when monitoring the model to provide a prompt to split the model based on the priority of the value of the variable.

In some cases, the performance of a model over time can be determined. For example, the average impact for a model can be determined. If the periodic monitoring of the model includes determining the impact for a first time period, an average impact can be determined for a second time period superseding the first time period. For example, if the model is monitored every day, an average impact can be determined for a week, a month, a year, and/or the like. As another example, if the model is monitored every week, an average impact can be determined for a month, a year, and/or the like. More concretely, the second time period can include a multiple of the first time period (e.g., 1 week includes 7 days, and/or the like). The average impact can include summing the multiple impacts determined for the first time period and dividing by the multiple value. As an example, if the model is monitored daily (e.g., the first time period includes a day), the impact values over a week (e.g., the second time period includes a week) can include a set of seven impact values (e.g., {5, 2, 13, 6, −2, 5, 8}). In this example, the average impact over the second time period can include

$$\frac{( 5 + 2 + 13 + 6 - 2 + 5 + 8 )}{7} \approx 5.3 .$$

In some cases, a percent change of impact can be determined between time intervals. For example, with reference to FIG. 9, if the time interval for which the average impact is determined is a month, the percent change of impact can be determined between months normalized by the starting month. For example, if the average impact for a first month is 25, the percent change of impact for the first month can be 0%. If the average impact for a second month is 25, then the percent change of impact between the first month and the second month can be 0%. If the average impact for a third month is 30, then the percent change of impact between the second month and the third month can include

$$\frac{30 - 25}{25} = 20 \% .$$

If the average impact for a fourth month is 25, then the percent change of impact between the third month and the fourth month can include

$$\frac{25 - 30}{30} \approx - 16.7 \% .$$

In some cases, the percent change of impact can be displayed in a plot with impact change percent on a vertical axis and time interval on the horizontal axis, such as, for example, in FIG. 9.

In some cases, a percent change of a population can be determined between time intervals. For example, in a first month, the model can receive a first count of inputs including a value of the variable and in a second month, the model can receive a second count of inputs including the value of the variable. For example, in May, the model can receive 30 inputs with “Gender=Female”, and in June, the model can receive 25 inputs with “Gender=Female”. As such, the percent change of the population with the value “Female” of the variable “Gender” can include

$$\frac{25 - 30}{30} \approx - 16.7 \% .$$

In some cases, an impact and a count can be provided over a time interval and for a contributing factor. For example, for a contributing factor (e.g., a value of a variable of the dataset), a first impact can be determined and displayed. For example, when a first submodel is considered as a contributing factor (e.g., such as “Overall” model, “Gender=Female” model, “State=CA” model, “Married=Single” model, “State=TX” model, “Gender=Male” model, and/or the like), a time interval metric, such as impact, count, and/or the like, can be determined for the first submodel. In some cases, the time interval metric can be displayed within a graphical user interface display space. In some cases, the first submodel can be retrained. In some cases, the first submodel can be split.

In some cases, a time interval metric of performance, such as a 30 day impact, can be determined to have degraded over the time interval. For example, with reference to the “Impact Change %” plot in FIG. 9, the performance of “Gender=Female” model can be determined to have degraded 9% between May and June. In some cases, in response to determining a degradation in the performance of a model, a prompt can be displayed within the graphical user interface display space. The prompt can notify a user that the performance of the model has degraded. In some cases, the prompt can include icons for retraining the model, splitting the model on the identified value of the variable responsible for performance degradation, and/or the like. For example, with reference to FIG. 9, the prompt can include an icon displaying the message “Model performance for Gender=Female has degraded 9% in the last 30 days” and including an icon to retrain the model (e.g., “Retrain Model”) and an icon to split the model (e.g., “Split Model for Gender”).

Retraining a model can include training the model on data more current than the historical data the model was previously trained on. In some cases, values of variables (e.g., constraints, resourcing levels, and/or the like) can be varied using a slider. For example, the value can be varied between a start value and an end value. In response to varying the constraint, the model can be retrained to optimize for the new constraint, a submodel and associated routing rule can be created for the new constraint, and/or the like.

In some cases, splitting a model on a value of a variable can include partitioning the dataset based on the value of the variable and training a submodel on elements (e.g., records, and/or the like) of the dataset that include the value of the variable. In some cases, as discussed above, a routing rule can be assigned to the submodel associating the submodel with the value of the variable when the value of the variable is provided as input to the submodel. In some cases, a model may degrade to the point that an overall model can perform better for a given value of the variable than a submodel associated with the given value of the variable with a routing rule. For a defined split, such as splitting over “Germany”, a “Germany” specific model can be trained and monitored. By monitoring a model defined over a given split, some implementations of the current subject matter can determine which models are highest performing for the defined split, and model performance degradation can be identified.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving input specifying a first selection of a first value of a variable of a dataset, the variable including a set of values associated with a model including a set of submodels, the set of submodels including a first submodel, the first value associated with the first submodel;
determining a first routing rule specifying use of the first submodel associated with the selected first value when the model receives the selected first value as input; and
deploying the model with the first routing rule.

2. The method of claim 1, further comprising:
receiving the dataset, the dataset including the variable, the variable including the set of values;
training, using the dataset, a first candidate model and a second candidate model;
determining a first performance of the first candidate model based on output of the first candidate model when the first value is provided as input to the first candidate model; and
determining a second performance of the second candidate model based on output of the second candidate model when the first value is provided as input to the second candidate model.

3. The method of claim 2, further comprising:
determining that the first performance is greater than the second performance;
associating, in response to determining that the first performance is greater than the second performance, the first candidate model with the first value; and
displaying, within a graphical user interface display space, a first icon associated with the first value, the first icon including a first characteristic representative of the first performance;
wherein the first candidate model is included in the model as the first submodel.

4. The method of claim 3, wherein the set of values includes a second value, the method further comprising:
determining a third performance of the first candidate model based on output of the first candidate model when the second value is provided as input to the first candidate model;
determining a fourth performance of the second candidate model based on output of the second candidate model when the second value is provided as input to the second candidate model;
determining that the fourth performance is greater than the third performance;
associating, in response to determining that the fourth performance is greater than the third performance, the second candidate model with the second value; and
displaying, within the graphical user interface display space, a second icon associated with the second value, the second icon including a characteristic representative of the fourth performance;
wherein the first characteristic and the second characteristic include size, color, shape, position, opacity, alignment, shading, origin, border, font, margin, or padding.

5. The method of claim 4, further comprising:
receiving input specifying a second selection of the second value; and
determining a second routing rule specifying use of the second candidate model associated with the selected second value in response to receiving the selected second value as input to the model;
wherein the model is deployed with the first routing rule and the second routing rule; and
wherein the set of submodels includes the second candidate model.

6. The method of claim 1, wherein the deploying further comprises:
integrating the model into an event-driven computing environment; and
providing a network interface with a private internet protocol address as an entry point for the model in the event-driven computing environment;
wherein the event-driven computing environment facilitates receiving an input value in the set of values and providing the input value as input to the model.

7. The method of claim 1, wherein the deploying further comprises:
encapsulating the model and the first routing rule in a virtual container configured to share a kernel, binaries, and libraries with a host; and
providing the virtual container.

8. The method of claim 1, wherein the input is received from a user, an application, a process, or a data source.

9. The method of claim 1, further comprising:
receiving data characterizing a first input to the model deployed with the first routing rule, the first input including the first value;
determining, based on the first routing rule, use of the first submodel in response to receiving the first value as input to the model;
determining, using the first input, a first output of the first submodel associated with the first value; and
providing the first output of the first submodel as output of the model.

10. The method of claim 9, wherein providing the first output includes transmitting, persisting, or displaying the first output.

11. The method of claim 1, wherein determining the first routing rule further comprises:
parsing an input signal for the first value;
filtering, using the parsed first value, the dataset for records of the dataset including the parsed first value; and
associating the filtered records with the first submodel.

12. The method of claim 1, further comprising:
monitoring the deployed model over time at least by determining a first performance of the model at a first time interval, determining a second performance of the model at a second time interval, and comparing the first performance and the second performance.

13. The method of claim 1, wherein the input specifying the first selection is received via a slider provided within a graphical user interface display space; and
wherein the slider is configured to adjust the first value at least by a percentage increase or a percentage decrease.

14. The method of claim 13, further comprising:
receiving, in response to receiving the input specifying the first selection via the slider, input specifying training the model;
partitioning, in response to receiving the input specifying training the model, the dataset on the first value of the variable; and
training, in response to partitioning the dataset, the first submodel on a partition of the dataset including the first value of the variable.

15. The method of claim 1, further comprising:
receiving input specifying an operational constraint and a cost-benefit tradeoff; and
associating the first submodel with the operational constraint and the cost-benefit tradeoff;
wherein the first routing rule further specifies use of the first submodel associated with the operational constraint and the cost-benefit tradeoff.

16. The method of claim 1, wherein the model is associated with an order of priority including a ranking of conditional statements associated with respective submodels in the set of submodels, the first submodel is associated with a first priority including a first conditional statement, the set of submodels further includes a second submodel, the second submodel associated with a second priority including a second conditional statement, the method further comprising:
receiving data characterizing a first input to the model, the first input including at least one condition; and
selecting, based on the at least one condition satisfying the first conditional statement, the first submodel.

17. A system comprising:
at least one data processor; and
memory storing instructions which when executed by the at least one data processor causes the at least one data processor to perform operations comprising:
receiving input specifying a first selection of a first value of a variable of a dataset, the variable including a set of values associated with a model including a set of submodels, the set of submodels including a first submodel, the first value associated with the first submodel;
determining a first routing rule specifying use of the first submodel associated with the selected first value when the model receives the selected first value as input; and
deploying the model with the first routing rule.

18. The system of claim 17, the operations further comprising:
receiving the dataset, the dataset including the variable, the variable including the set of values;
training, using the dataset, a first candidate model and a second candidate model;
determining a first performance of the first candidate model based on output of the first candidate model when the first value is provided as input to the first candidate model; and
determining a second performance of the second candidate model based on output of the second candidate model when the first value is provided as input to the second candidate model.

19. The system of claim 18, the operations further comprising:
determining that the first performance is greater than the second performance;
associating, in response to determining that the first performance is greater than the second performance, the first candidate model with the first value; and
displaying, within a graphical user interface display space, a first icon associated with the first value, the first icon including a first characteristic representative of the first performance;
wherein the first candidate model is included in the model as the first submodel.

20. The system of claim 19, wherein the set of values includes a second value, the operations further comprising:
determining a third performance of the first candidate model based on output of the first candidate model when the second value is provided as input to the first candidate model;
determining a fourth performance of the second candidate model based on output of the second candidate model when the second value is provided as input to the second candidate model;
determining that the fourth performance is greater than the third performance;
associating, in response to determining that the fourth performance is greater than the third performance, the second candidate model with the second value; and
displaying, within the graphical user interface display space, a second icon associated with the second value, the second icon including a characteristic representative of the fourth performance;
wherein the first characteristic and the second characteristic include size, color, shape, position, opacity, alignment, shading, origin, border, font, margin, or padding.
